(19) United States
(12) Patent Application Publication
(10) Pub. No.: US 2026/0036709 A1
(43) Pub. Date: Feb. 5, 2026

(54) Building Near Surface Velocity Models Using Uphole and Full Waveform Seismic Surveys

(71) Applicant: Saudi Arabian Oil Company, Dhahran (SA)

(72) Inventors: Daniele Colombo, Dhahran (SA); Ersan Turkoglu, Dhahran (SA); Ernesto Sandoval Curiel, Dhahran (SA); Taqi Yousuf Alyousuf, Saihat (SA)

(21) Appl. No.: 18/794,653

(22) Filed: Aug. 5, 2024

(51) Int. Cl. G01V 1/28; E21B 44/00; G01V 1/30; G01V 1/34

(52) U.S. Cl. CPC G01V 1/282; E21B 44/00; G01V 1/303; G01V 1/345; E21B 2200/20; E21B 2200/22

(57) ABSTRACT

Systems and methods for building a near surface velocity model for a subsurface formation include obtaining seismic data representing a subsurface formation; forming seismic gathers based on the seismic data; and determining uphole vertical velocities for the subsurface formation based on uphole seismic survey data. A training dataset is formed including input features that include a subset of the seismic gathers and labeled output data that includes the uphole vertical velocities corresponding to the subset of seismic gathers. A machine learning model is trained using the training dataset; and a near surface velocity model is generated for the subsurface formation using the machine learning model that takes as input the seismic gathers.

### TECHNICAL FIELD

The present disclosure generally relates to building near surface velocity models for a subsurface formation using uphole seismic surveys.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications such as, for example, identification of potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

### SUMMARY

Seismic exploration on land can be affected by near surface complexities such as the unsaturated portion of the subsurface, commonly referred to as the “weathering” layer. Weathering layers present sharp vertical, and sometimes horizontal, variations in physical parameters, such as extremely low velocities associated with unconsolidated sediments and undersaturated conditions. The effects on the physical parameters can be worsened in arid environments where the depth of the water table can be hundreds of meters below the topographic surface. Seismic data used for exploration of hydrocarbon resources can be corrected by the large travel time (e.g., “statics”) in the low velocity formations characterizing the near surface (e.g., sand dunes) in order to reconstruct the deep geological structures holding the hydrocarbons with geometrical consistency. Improper evaluation of the thickness and the velocities of the weathering layer can introduce unwanted distortions in the time and depth seismic images causing an incorrect interpretation of subsurface structural or stratigraphic features (e.g., leads) to be drilled. The very shallow near surface can be difficult to reconstruct with conventional seismic acquisition setups that target deep structures. The acquisition parameters of seismic campaigns tuned for performance to explore deep geological structures can result in an inability to accurately characterize the very shallow weathering layer directly with the use of the collected seismic records (e.g., through inversion).

Uphole seismic surveys can be used to specifically investigate the shallow near surface. A source is lowered within a shallow borehole and the uphole times are recorded by seismic receivers (e.g., geophones) located on the surface in proximity of the borehole. The vertical travel times can be interpreted for the interval velocities and a detailed velocity profile can be obtained describing the velocity structure of the weathering layer and of the investigated near surface below the weathering layer.

This disclosure describes an approach for building continuous three-dimensional (3D) velocity models of the near surface by using a combination of uphole vertical velocities and full seismic waveform data. The seismic waveform data can be preconditioned and reduced (e.g., gathered) to reduce the dependency of the seismic information on local shallow conditions (e.g., different couplings of the source or of the receivers). A machine learning model can be trained with training data where the input features include seismic waveform data and labels for the input features include uphole data corresponding to the seismic waveform data. The trained machine learning model can be used to generate a near surface velocity model taking as input the full waveform seismic data.

Implementations of the systems and methods of this disclosure can provide various technical benefits. This approach reduces the computational complexity and thereby reduces the computational resources required to reconstruct velocities in the near surface. This approach provides a high-resolution velocity model using the spatially sparse uphole data without “bullseye” effects (e.g., rapid parameter changes near boreholes) or uninformatively smooth velocity models that are generated by interpolated and regularized models. This approach provides a method to propagate localized velocity calibrations to generate continuous 3D velocity models of a subsurface formation that can be used in seismic processing in time and depth. This approach can utilize existing, large databases of uphole seismic survey data to calibrate the near surface low velocity layer (LVL) and the geological strata underneath the LVL. This approach can be applied to reconstruct velocities in the subsurface corresponding with the depth of the wellbore. For example, for a shallow borehole (e.g., a few hundred meters) this approach can be used to reconstruct the velocities in the weathering section, and for a deep borehole (e.g., a few kilometers), this approach can be used to reconstruct the velocities for the whole overburden.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey being performed to map subsurface features such as facies and faults.

FIG. 2 illustrates a three-dimensional hypercube in a common midpoint offset domain.

FIGS. 3A-3C illustrate stacking of seismic traces to form a seismic gather.

FIG. 4 is a comparison of a shot gather and a virtual shot gather (VSG).

FIG. 5 is a workflow illustrating an uphole seismic survey.

FIG. 6 is a flowchart for a method of building a near surface velocity model.

FIG. 7 illustrates example VSGs represented as normalized amplitude and unwrapped and normalized phase.

FIG. 8 shows examples of training data pairs for use in training a machine learning model to build a near surface velocity model.

FIGS. 9A and 9B show a comparison between an offset plane from a 3D volume of VSGs and the near surface velocity model generated using the approach of the present disclosure.

FIGS. 10A and 10B show a comparison between a near surface velocity model generated using straight interpolation of uphole velocity data and a near surface velocity model generated using the approach of the present disclosure.

FIGS. 11A and 11B show a comparison between near surface velocities determined by a full waveform inversion and near surface velocities generated by using the approach of the present disclosure.

FIG. 12 illustrates hydrocarbon production operations that include field operations and computational operations, according to some implementations.

FIG. 13 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

Seismic exploration on land can be affected by near surface complexities such as the unsaturated portion of the subsurface, commonly referred to as the “weathering” layer. Weathering layers present sharp vertical, and sometimes horizontal, variations in physical parameters, such as extremely low velocities associated with unconsolidated sediments and undersaturated conditions. The effects on the physical parameters can be worsened in arid environments where the depth of the water table can be hundreds of meters below the topographic surface. Seismic data used for exploration of hydrocarbon resources can be corrected by the large travel time (e.g., “statics”) in the low velocity formations characterizing the near surface (e.g., sand dunes) in order to reconstruct the deep geological structures holding the hydrocarbons with geometrical consistency. Improper evaluation of the thickness and the velocities of the weathering layer can introduce unwanted distortions in the time and depth seismic images causing an incorrect interpretation of subsurface structural or stratigraphic features (e.g., leads) to be drilled. The very shallow near surface can be difficult to reconstruct with conventional seismic acquisition setups that target deep structures. The acquisition parameters of seismic campaigns tuned for performance to explore deep geological structures can result in an inability to accurately characterize the very shallow weathering layer directly with the use of the collected seismic records (e.g., through inversion).

Uphole seismic surveys can be used to specifically investigate the shallow near surface. A source is lowered within a shallow borehole and the uphole times are recorded by seismic receivers (e.g., geophones) located on the surface in proximity of the borehole. The vertical travel times can be interpreted for the interval velocities and a detailed velocity profile can be obtained describing the velocity structure of the weathering layer and of the investigated near surface below the weathering layer.

This disclosure describes an approach for building continuous three-dimensional (3D) velocity models of the near surface by using a combination of uphole vertical velocities and full seismic waveform data. The seismic waveform data can be preconditioned and reduced (e.g., gathered) to reduce the dependency of the seismic information on local shallow conditions (e.g., different couplings of the source or of the receivers). A machine learning model can be trained with training data where the input features include seismic waveform data and labels for the input features include uphole data corresponding to the seismic waveform data. The trained machine learning model can be used to generate a near surface velocity model taking as input the full waveform seismic data.

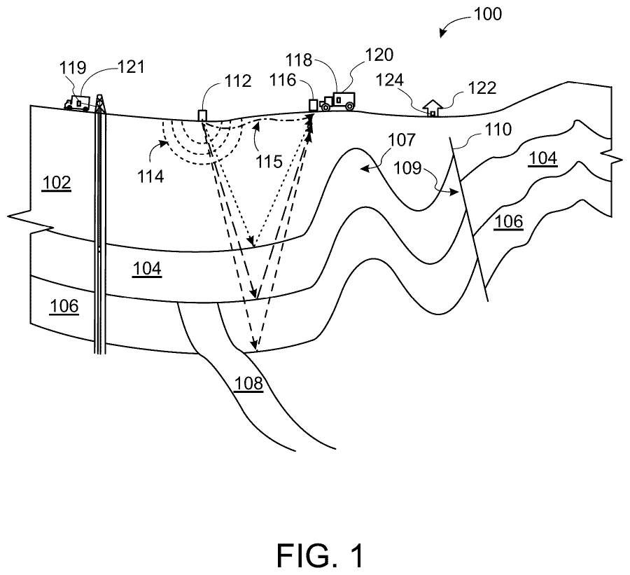

FIG. 1 is a schematic view of a seismic survey being performed to map subsurface features such as facies and faults in a subsurface formation 100. The subsurface formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subsurface formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

In some implementations, results generated by the computer system 124 may be displayed for user viewing using local or remote monitors or other display units. One approach to analyzing seismic data is to associate the data with portions of a seismic cube representing the subsurface formation 100. The seismic cube can also display results of the analysis of the seismic data associated with the seismic survey.

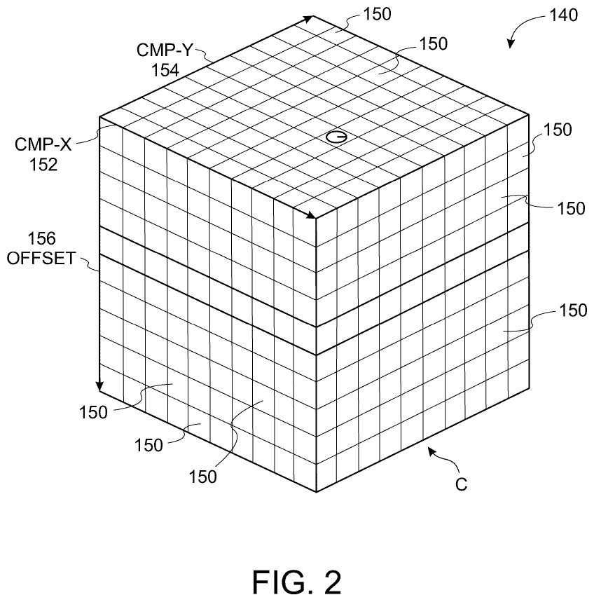

FIG. 2 illustrates a seismic cube 140 representing at least a portion of the subsurface formation 140. The seismic cube 140 is composed of a number of voxels 150. A voxel is a volume element, and each voxel corresponds, for example, with a seismic sample along a seismic trace. The cubic volume C is composed along intersection axes of offset spacing times based on a Delta-X spacing 152, a Delta-Y offset spacing 154, and a Delta-Offset offset spacing 156. Within each voxel 150, statistical analysis can be performed on data assigned to that voxel to determine, for example, multimodal distributions of travel times and derive robust travel time estimates (according to mean, median, mode, standard deviation, kurtosis, and other suitable statistical accuracy analytical measures) related to azimuthal sectors allocated to the voxel 150.

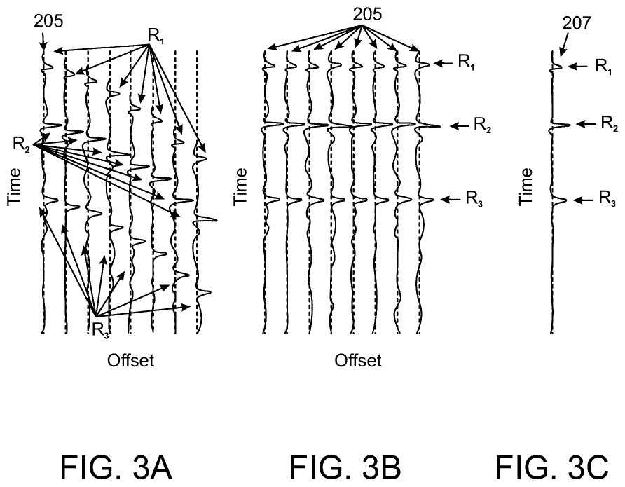

FIGS. 3A, 3B, and 3C schematically illustrate the process of stacking a group of seismic traces 205 to improve the signal to noise ratio of the traces. FIG. 3A illustrates a common midpoint (CMP) gather of eight traces 205 generated by a set of sources and sensors that share a common midpoint. For ease of explanation, the traces are assumed to have been generated by reflections from three horizontal horizons.

The traces 205 are arranged with increasing offset from the CMP. The offset of the traces 205 from the CMP increase from left to right and the reflection time increases from top to bottom. Increasing offset from the common midpoint increases the angle of a seismic wave that between a source and a sensor, increases the distance the wave travels between the source and the sensor, and increases the slant reflection time. The increasing time for the reflections (R₁, R₂, R₃) from each of the horizons to arrive for source-sensor pairs with increasing offsets from the CMP reflects this increased slant time.

FIG. 3B shows the traces 205 after normal moveout (NMO) correction. NMO is the difference between vertical reflection time and the slant reflection time for a given source-sensor pair. This correction places reflections (R₁, R₂, R₃) from common horizons at the same arrival time. The NMO correction is a function of the vertical reflection time for a specific horizon, the offset for a specific source-sensor pair, and the velocity of the seismic wave in the subsurface formation. The vertical reflection time for a specific horizon and the offset for a specific source-sensor pair are known parameters for each trace. However, the velocity is usually not readily available. As previously discussed, the velocity of seismic waves depends on properties such as, for example, density, porosity, and fluid content of the medium through which the seismic waves are traveling, and consequently, the velocity varies with location in the subsurface formation being studied.

FIG. 3C shows a stack trace 207 generated by summing the traces 205 of the CMP gather and dividing the resulting amplitudes by the number of traces in the gather. The number of traces in the gather is also referred to as the fold of the gather. The noise tends to cancel out and the reflections (R₁, R₂, R₃) from the horizons of the subsurface formation are enhanced.

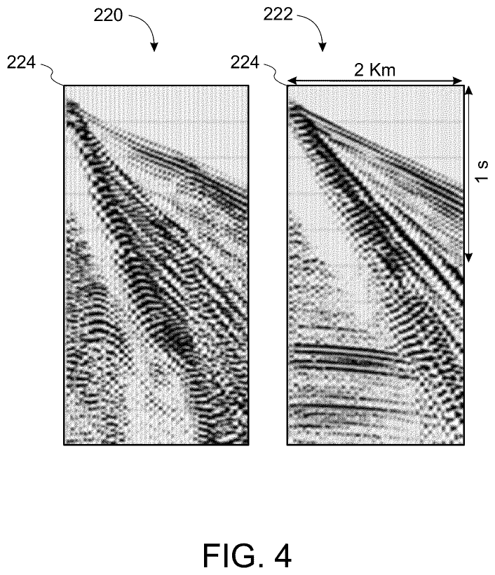

FIG. 4 illustrates an example shot gather 220 compared to a virtual shot gather (VSG) 222. The shot gather 220 has a shot point 224 located at the XY midpoint coordinates in the top-left of the figure. The shot gather 220 is compared to the VSG 222 having the same XY midpoint position. The VSG 222 is constructed in the manner described above with surface-consistent residual static corrections applied. The surface-consistent residual static corrections include a time-shift based on cross-correlations of each seismic trace with the pilot trace. The VSG 222 increases the signal-to-noise (S/N) ratio of the signal (e.g., decreasing the relative noise of the signal). The construction of the VSG 222 preserves the coherent signal and reduces the uncorrelated noise providing the increased S/N ratio.

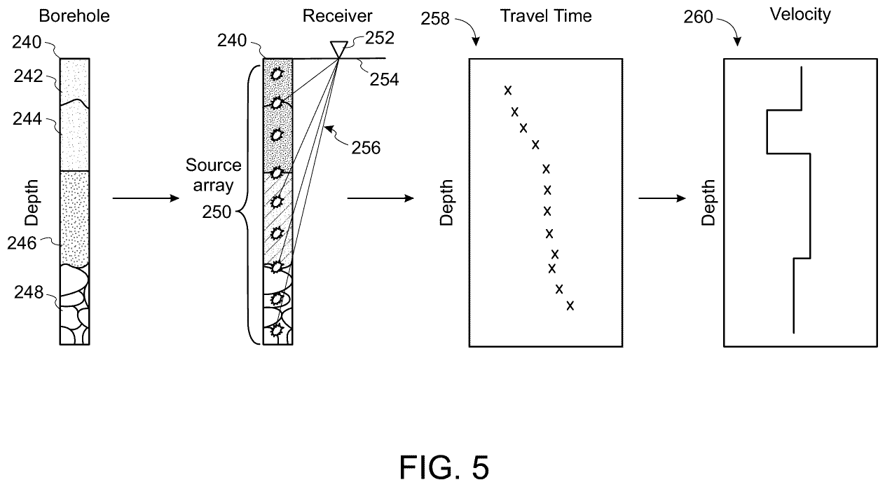

FIG. 5 is a workflow for performing an uphole seismic survey. A shallow borehole 240 (e.g., a few hundred meters in depth) is drilled into a subsurface formation. The borehole 240 can penetrate several lithological layers 242-248. A source array 250 is placed into the borehole 240 with sensors at multiple depths in the borehole 240. A seismic receiver 252 (e.g., a geophone) is placed on the surface 254 in proximity to but offset from the borehole 240. Acoustic waves 256 travel from the source array 250 to the receiver 252. The receiver 252 records the travel time of the acoustic signals 256. The travel times can be recorded as a function of depth and a plot 258 generated to visualize the variation in travel time with depth in the borehole. The travel times associated with the vertical travel path are interpreted to determine interval velocities, and a detailed velocity profile 260 is generated describing the velocity structure of the weathering layer and of the near surface below the weathering layer. Placing receivers in the borehole and sources on the surface has the same effect as travel times and wave propagation following the principle of reciprocity (e.g., the time required for seismic energy to travel between two points is independent of the direction it is traveling).

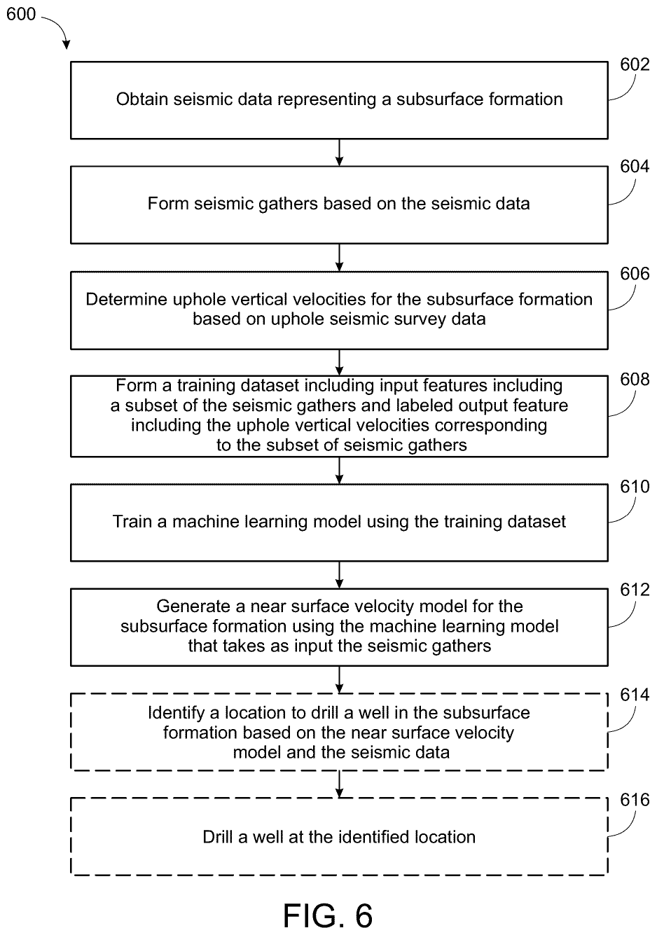

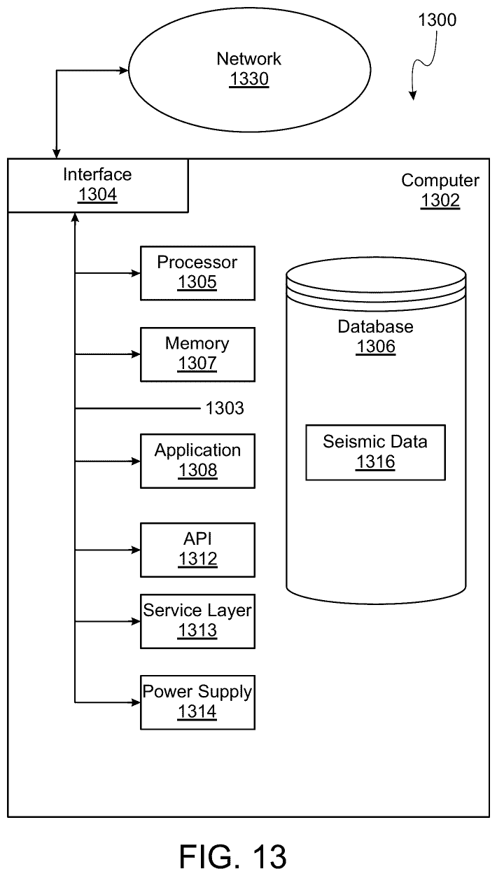

FIG. 6 is an example method 600 for building a near surface velocity model for a subsurface formation. The method 600 can be implemented on a data processing system such as a computer or control system with one or more processors (e.g., computer systems 124, the computer system of FIG. 13).

The data processing system obtains seismic data representing a subsurface formation (step 602). For example, the data processing system obtains the seismic data from a seismic survey (e.g., the seismic survey of FIG. 1). The seismic data can be 3D seismic data or two-dimensional (2D) seismic data. In some implementations, the data processing system obtains the seismic data by accessing previously acquired data from a data store. For example, the data processing system accesses a hardware storage device and reads the seismic data from the hardware storage device.

The data processing system forms seismic gathers based on the seismic data (step 604). For example, the data processing system forms the seismic gathers as described in reference to FIGS. 2-4. The seismic gathers can include, for example, VSGs, common midpoint gathers, shot gathers, receiver gathers, or common image gathers.

In some implementations, the data processing system forms VSGs based on the seismic data. The data processing system can sort the seismic data into bins in a midpoint and offset hypercube. The data processing system can perform surface consistent corrections to the sorted seismic data. For example, for each bin of the hypercube, the data processing system determines a surface-consistent residual static correction by performing a cross-correlation of each seismic trac with a pilot trace to determine a time shift. The data processing system can determine the surface-consistent residual static correction based on inversions of the time shift for a seismic source position and a seismic receiver position. The data processing system can stack the seismic traces in each hypercube bin. The data processing system can form the VSG by collecting the stacked seismic traces for offset bins in the hypercube. The resulting VSG is a high S/N volumetric representation of the seismic energy impinging at the CMP spatial location. Further details on the formation of VSGs and surface-consistent static corrections are discussed in U.S. Pat. No. 11,397,273 the contents of which are hereby incorporated by reference in their entirety.

In some implementations, the data processing system transforms the seismic gathers to time series data, frequency domain data, or Laplace-Fourier domain data. The data processing system can further normalize the data for efficient use by a machine learning model. For example, in the Laplace-Fourier domain, the VSGs can be represented by a normalized amplitude and an unwrapped and normalized phase.

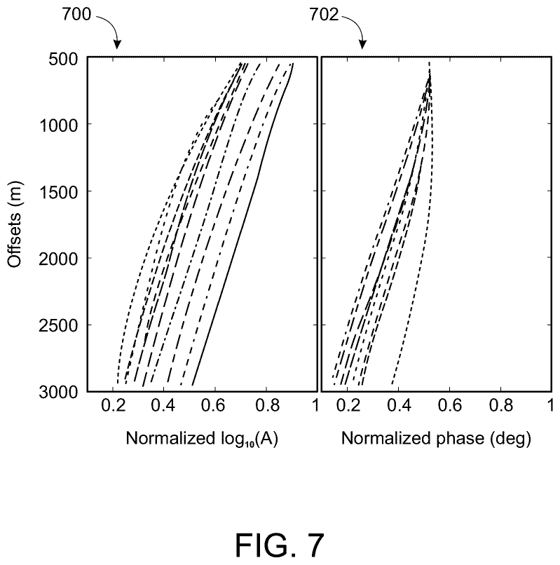

Turning briefly to FIG. 7, FIG. 7 illustrates an example of Laplace-Fourier transformed VSG data. The VSG data are represented in terms of normalized (log 10) amplitude 700, and unwrapped (and normalized) phase 702.

Returning to FIG. 6, the data processing system determines uphole vertical velocities for the subsurface formation based on uphole seismic survey data (step 606). The uphole seismic survey can be conducted in a manner similar to the workflow of FIG. 5. The uphole vertical velocities can be represented in terms of vertical velocity functions. The data processing system can determine the vertical velocities using statistical and/or machine learning approaches.

Other methods of determining the vertical velocities include identifying linear branches of a travel time function and deriving the interval velocity from the slope of the identified segment. The depth of the intersection of the linear segments defines the depth interval where the velocity is applied (see, e.g., FIG. 5). Alternatively, a division of a depth interval over the time interval can be performed for each source-receiver pair; however, this approach can be unstable because the noise can propagate out of control giving unreliable velocity estimates. Therefore, the uphole travel time profile would need to undergo an interpretation.

The data processing system forms a training dataset where the input features include a subset of the seismic gathers and the labeled output data includes the uphole vertical velocities corresponding to the subset of seismic gathers (step 608). The data processing system can select the subset of seismic gathers based on the geolocation of the seismic gathers and the geolocation of the uphole vertical velocities. For example, the data processing system can determine the geolocation of VSG data using the CMP spatial location and select the subset of VSG data that corresponds to spatial positions of the uphole seismic survey data.

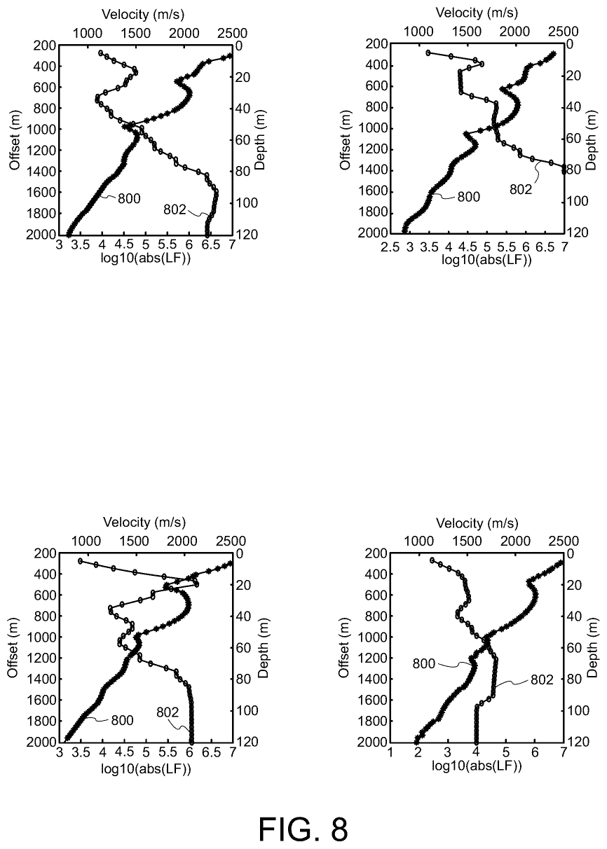

FIG. 8 shows example training pairs that can be used to train a machine learning model. The input features are Laplace-Fourier transformed VSG data 800 and the corresponding output labels are the uphole vertical velocities 802. The VSG data 800 is plotted as the base-10 logarithm of the absolute value of the Laplace-Fourier data versus the offset in meters. The uphole vertical velocities 802 are plotted as velocity in meters per second (m/s) versus depth in meters. VSG data can be represented in frequency domain (e.g., real/imaginary or magnitude/phase) as well as in time domain.

Returning to FIG. 6, the data processing system trains a machine learning model using the training dataset (step 610). The machine learning model can be, for example, an artificial neural network (ANN), a convolutional neural network (CNN), a long-short term memory (LSTM) model, a Gaussian process regression (GPR) model, or a Fourier neural operators (FNO) model. Multiple machine learning architectures can be tested to determine which architecture to use to generate the velocity models.

Once the data processing system has completed training of the machine learning model, the data processing system generates a near surface velocity model for the subsurface formation using the machine learning model that takes as input the seismic gathers (step 610). The data processing system can utilize the full set of seismic data as input to the machine learning model to generate the near surface velocity model. The data processing system can produce a high-resolution, continuous, 3D near surface velocity model using the machine learning model. The high-resolution, continuous, 3D near surface velocity model can reconstruct all of the velocity intervals successfully including velocity reversals. Conventional near surface velocity models are typically derived using refraction data (e.g., diving waves) acquired on the surface that are not sensitive to velocity reversals resulting in possible hidden layers not reconstructed in the near surface. The near surface velocity model can constitute an uphole-calibrated 3D velocity volume of the shallow near surface which includes the weathering LVL and the deeper near surface velocity structures as sampled by the uphole seismic survey.

The data processing system can identify a location to drill a well in the subsurface formation based on the near surface velocity model and the seismic data (step 614). Further, the data processing system can drill a well at the identified location by controlling drilling equipment to drill the well based on the near surface velocity model (step 616). For example, the near surface velocity model can indicate drilling hazards (e.g., cavities) that can cause the well to cave in. The data processing system can control the drilling equipment to avoid the indicated drilling hazards.

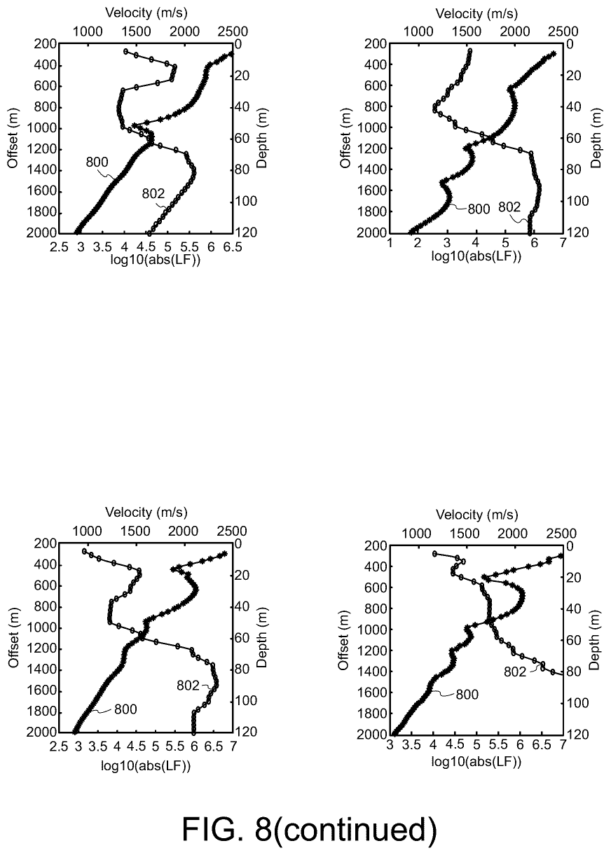

FIG. 9A shows an example of a full 3D VSG dataset transformed into the Laplace-Fourier (LF) domain (18 Hz, 10 s⁻¹) and turned into amplitude and phase representation (normalized log 10 of the amplitude in the figure). The VSG is a volumetric representation of the seismic energy reconstructed at the CMP location. A convenient representation of the geological structure response can be obtained by representing the transformed LF VSGs in terms of offset planes. FIG. 9A shows the 3D VSG dataset transformed in LF for a common (near) offset panel (real coefficients of the LF transform are shown), where near offsets include short offsets, for example, 500-2000 meters. The seismic data shows characteristic geological features of the area, such as drainage channels 900 and sinkholes 902 (circular features to the center-right of the figure).

FIG. 9B shows a near surface velocity model generated by an implementation of the method 600. A trained machine learning model, trained using uphole survey data, took as input the VSGs from the whole seismic survey of the subsurface formation (an offset plane of the VSGs is shown in FIG. 9A). The machine learning model produced the velocity distribution shown in FIG. 9B where the VSG LF data are mapped into the near surface velocities. The obtained near surface velocity map is a high-resolution representation of the input data obtained from the machine learning algorithm. In this example, a fully connected ANN with 30 neurons and 1 hidden layer was used.

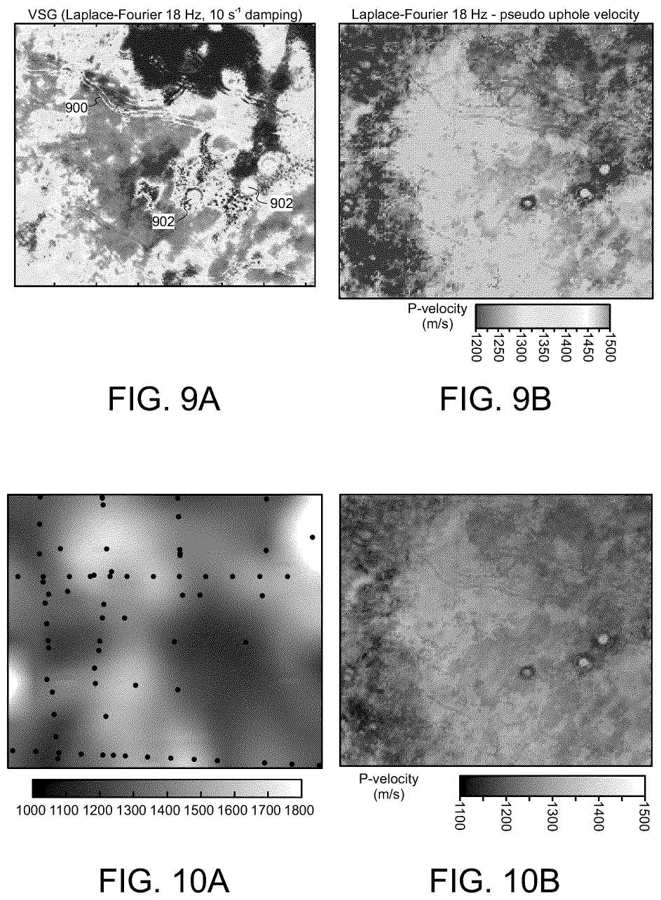

FIGS. 10A and 10B show a comparison between a straight interpolation of uphole velocities (FIG. 10A) to generate a 3D velocity model and the velocity model generated using the trained machine learning model (FIG. 10B) using uphole vertical velocities and full waveform seismic data (method 600). The straight interpolation of the uphole velocities results in the “bullseye” effect where the seismic velocities are higher near the sampling locations (black dots) and lower farther away from the sampling locations. The machine learning generated velocity model (FIG. 10B) shows fine details of the subsurface formation as discussed in reference to FIGS. 9A and 9B.

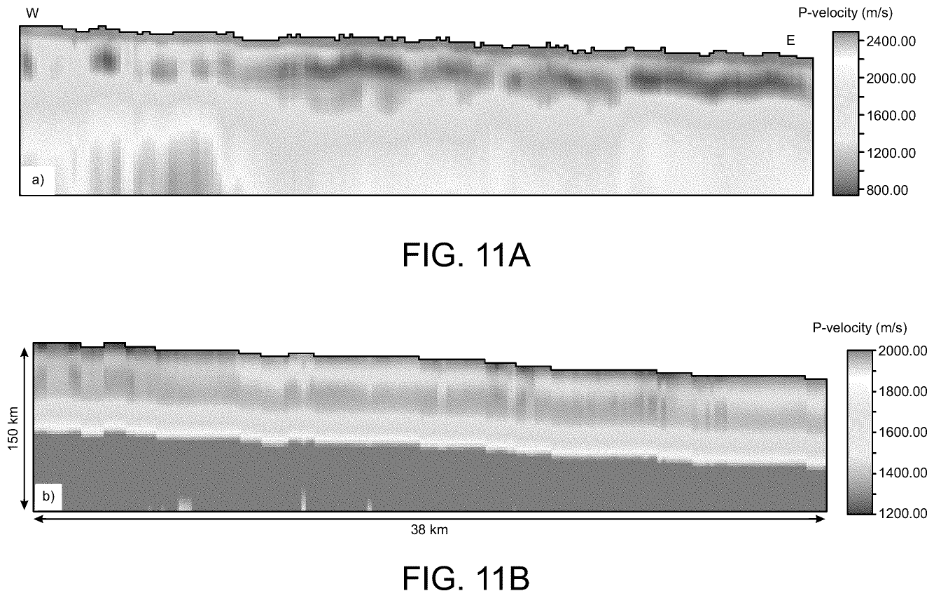

FIGS. 11A and 11B show a comparison between a west-east (W-E) velocity cross-section through the reconstructed velocity volumes generated using a deterministic LF full waveform inversion (FWI) (FIG. 11A, 18 Hz, 10 s−1) and the near surface velocity model built using a supervised machine learning model using uphole seismic data and full waveform seismic data (FIG. 11B, method 600). The near surface velocity model generated by the machine learning model shows similar shallow features as the FWI model with better lateral continuity.

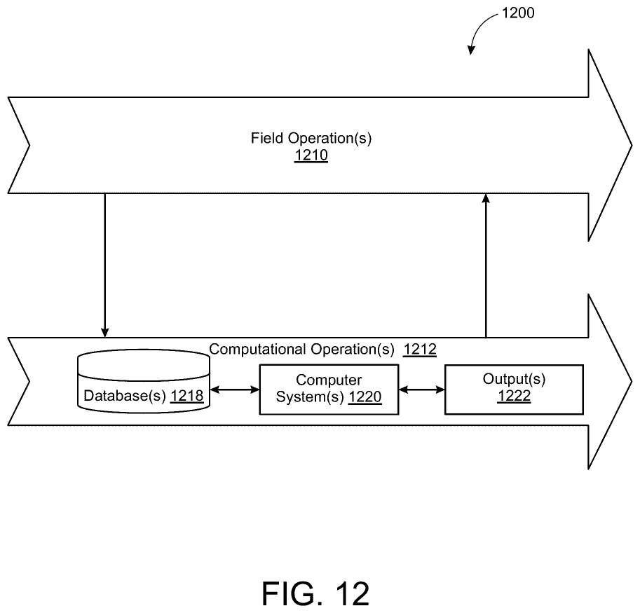

FIG. 12 illustrates hydrocarbon production operations 1200 that include both one or more field operations 1210 and one or more computational operations 1212, which exchange information and control exploration for the production of hydrocarbons. In some implementations, outputs of techniques of the present disclosure (e.g., the method 500) can be performed before, during, or in combination with the hydrocarbon production operations 1200, specifically, for example, either as field operations 1210 or computational operations 1212, or both.

Examples of field operations 1210 include forming/drilling a wellbore, hydraulic fracturing, producing through the wellbore, injecting fluids (such as water) through the wellbore, to name a few. In some implementations, methods of the present disclosure can trigger or control the field operations 1210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1210 and responsively triggering the field operations 1210 including, for example, generating plans and signals that provide feedback to and control physical components of the field operations 1210. Alternatively, or in addition, the field operations 1210 can trigger the methods of the present disclosure. For example, implementing physical components (including, for example, hardware, such as sensors) deployed in the field operations 1210 can generate plans and signals that can be provided as input or feedback (or both) to the methods of the present disclosure.

Examples of computational operations 1212 include one or more computer systems 1220 that include one or more processors and computer-readable media (e.g., non-transitory computer-readable media) operatively coupled to the one or more processors to execute computer operations to perform the methods of the present disclosure. The computational operations 1212 can be implemented using one or more databases 1218, which store data received from the field operations 1210 and/or generated internally within the computational operations 1212 (e.g., by implementing the methods of the present disclosure) or both. For example, the one or more computer systems 1220 process inputs from the field operations 1210 to assess conditions in the physical world, the outputs of which are stored in the databases 1218. For example, seismic sensors of the field operations 1210 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1212 where they are stored in the databases 1218 and analyzed by the one or more computer systems 1220.

In some implementations, one or more outputs 1222 generated by the one or more computer systems 1220 can be provided as feedback/input to the field operations 1210 (either as direct input or stored in the databases 1218). The field operations 1210 can use the feedback/input to control physical components used to perform the field operations 1210 in the real world.

For example, the computational operations 1212 can process the seismic data to generate three-dimensional (3D) maps of the subsurface formation. The computational operations 1212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1212 to process new information about the formation and control the drilling to adjust to the observed conditions in real-time.

The one or more computer systems 1220 can update the 3D maps of the subsurface formation as information from one exploration well is received and the computational operations 1212 can adjust the location of the next exploration well based on the updated 3D maps. Similarly, the data received from production operations can be used by the computational operations 1212 to control components of the production operations. For example, production well and pipeline data can be analyzed to predict slugging in pipelines leading to a refinery and the computational operations 1212 can control machine operated valves upstream of the refinery to reduce the likelihood of plant disruptions that run the risk of taking the plant offline.

In some implementations of the computational operations 1212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 13 is a block diagram of an example computer system 1300 used to provide computational functionalities associated with described algorithms, methods, functions, processes, flows, and procedures described in the present disclosure, according to some implementations of the present disclosure. The illustrated computer 1302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI).

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a high level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both), over the system bus 1303. Interfaces can use an application programming interface (API) 1312, a service layer 1313, or a combination of the API 1312 and service layer 1313. The API 1312 can include specifications for routines, data structures, and object classes. The API 1312 can be either computer-language independent or dependent. The API 1312 can refer to a complete interface, a single function, or a set of APIs.

The service layer 1313 can provide software services to the computer 1302 and other components (whether illustrated or not) that are communicably coupled to the computer 1302. The functionality of the computer 1302 can be accessible for all service consumers using this service layer. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 includes an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface's hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and can manipulate data to perform the operations of the computer 1302, including operations using algorithms, methods, functions, processes, flows, and procedures as described in the present disclosure.

The computer 1302 also includes a database 1306 that can hold data for the computer 1302 and other components connected to the network 1330 (whether illustrated or not). For example, database 1306 can hold data 1316 (e.g., resistivity data). For example, database 1306 can be an in-memory, conventional, or a database storing data consistent with the present disclosure. In some implementations, database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

The application 1308 can be an algorithmic software engine providing functionality according to particular needs, desires, or particular implementations of the computer 1302 and the described functionality. For example, application 1308 can serve as one or more components, modules, or applications. Further, although illustrated as a single application 1308, the application 1308 can be implemented as multiple applications 1308 on the computer 1302. In addition, although illustrated as internal to the computer 1302, in alternative implementations, the application 1308 can be external to the computer 1302.

The computer 1302 can also include a power supply 1314. The power supply 1314 can include a rechargeable or non-rechargeable battery that can be configured to be either user- or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system containing computer 1302, with each computer 1302 communicating over network 1330. Further, the terms “client,” “user,” and other appropriate terminology can be used interchangeably, as appropriate, without departing from the scope of the present disclosure. Moreover, the present disclosure contemplates that many users can use one computer 1302 and one user can use multiple computers 1302.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### EXAMPLES

In an example implementation, a computer-implemented method for building a near surface velocity model for a subsurface formation includes obtaining, by one or more processors, seismic data representing a subsurface formation; forming, by the one or more processors, seismic gathers based on the seismic data; determining, by the one or more processors, uphole vertical velocities for the subsurface formation based on uphole seismic survey data; forming, by the one or more processors, a training dataset including input features including a subset of the seismic gathers and labeled output data including the uphole vertical velocities corresponding to the subset of seismic gathers; training, by the one or more processors, a machine learning model using the training dataset; and generating, by the one or more processors, a near surface velocity model for the subsurface formation using the machine learning model that takes as input the seismic gathers.

In an aspect combinable with the example implementation, the seismic gathers include virtual shot gathers, common midpoint gathers, shot gathers, receiver gathers, or common image gathers.

In another aspect combinable with one, some, or all of the previous aspects, the seismic gathers include virtual shot gathers, and forming the virtual shot gathers includes sorting, by the one or more processors, the seismic data into bins in a midpoint and offset hypercube; performing, by the one or more processors, surface-consistent corrections to the sorted seismic data; stacking, by the one or more processors, seismic traces in each hypercube bin; and forming, by the one or more processors, the virtual shot gathers by collecting the stacked seismic traces for offset bins in the hypercube.

Another aspect combinable with one, some, or all of the previous aspects includes transforming, by the one or more processors, the virtual shot gathers to a Laplace-Fourier domain, where the virtual shot gathers are represented by a normalized amplitude and an unwrapped and normalized phase.

In another aspect combinable with one, some, or all of the previous aspects, the near surface velocity model includes a continuous, three-dimensional near surface velocity model of the subsurface formation.

In another aspect combinable with one, some, or all of the previous aspects, the machine learning model includes an artificial neural network, a convolutional neural network, a long-short term memory model, a Gaussian process regression model, or a Fourier neural operators model.

Another aspect combinable with one, some, or all of the previous aspects includes selecting the subset of the seismic gathers by determining, by the one or more processors, a geolocation of the seismic gathers; and selecting seismic gathers whose geolocation corresponds with a spatial position of the uphole seismic survey data.

Another aspect combinable with one, some, or all of the previous aspects includes identifying, by the one or more processors, a location to drill a well in the subsurface formation based on the near surface velocity model and the seismic data; and drilling a well at the identified location by controlling, by the one or more processors, drilling equipment to drill the well.

In another example implementation, a computer system includes one or more processors; and a computer-readable medium storing instructions executable by the one or more processors, the instructions when executed by the one or more processers cause the one or more processors to perform operations including obtaining seismic data representing a subsurface formation; forming seismic gathers based on the seismic data; determining uphole vertical velocities for the subsurface formation based on uphole seismic survey data; forming a training dataset comprising input features comprising a subset of the seismic gathers and labeled output data comprising the uphole vertical velocities corresponding to the subset of seismic gathers; training a machine learning model using the training dataset; and generating a near surface velocity model for the subsurface formation using the machine learning model that takes as input the seismic gathers.

In an aspect combinable with the example implementation, the seismic gathers include virtual shot gathers, common midpoint gathers, shot gathers, receiver gathers, or common image gathers.

In another aspect combinable with one, some, or all of the previous aspects, the seismic gathers include virtual shot gathers, and forming the virtual shot gathers includes sorting the seismic data into bins in a midpoint and offset hypercube; performing surface-consistent corrections to the sorted seismic data; stacking seismic traces in each hypercube bin; and forming the virtual shot gathers by collecting the stacked seismic traces for offset bins in the hypercube.

In another aspect combinable with one, some, or all of the previous aspects, the near surface velocity model includes a continuous, three-dimensional near surface velocity model of the subsurface formation.

In another aspect combinable with one, some, or all of the previous aspects, the machine learning model includes an artificial neural network, a convolutional neural network, a long-short term memory model, a Gaussian process regression model, or a Fourier neural operators model.

In another aspect combinable with one, some, or all of the previous aspects, the instructions include selecting the subset of the seismic gathers by determining a geolocation of the seismic gathers; and selecting seismic gathers whose geolocation corresponds with a spatial position of the uphole seismic survey data.

In another example implementation, one or more non-transitory, machine-readable storage devices storing instructions executable by a computer system, the instructions when executed cause the computer system to perform operations including obtaining seismic data representing a subsurface formation; forming seismic gathers based on the seismic data; determining uphole vertical velocities for the subsurface formation based on uphole seismic survey data; forming a training dataset comprising input features comprising a subset of the seismic gathers and labeled output data comprising the uphole vertical velocities corresponding to the subset of seismic gathers; training a machine learning model using the training dataset; and generating a near surface velocity model for the subsurface formation using the machine learning model that takes as input the seismic gathers.

In an aspect combinable with the example implementation, the seismic gathers include virtual shot gathers, and forming the virtual shot gathers includes sorting the seismic data into bins in a midpoint and offset hypercube; performing surface-consistent corrections to the sorted seismic data; stacking seismic traces in each hypercube bin; and forming the virtual shot gathers by collecting the stacked seismic traces for offset bins in the hypercube.

In another aspect combinable with one, some, or all of the previous aspects, the instructions include transforming the virtual shot gathers to a Laplace-Fourier domain, where the virtual shot gathers are represented by a normalized amplitude and an unwrapped and normalized phase.

In another aspect combinable with one, some, or all of the previous aspects, the near surface velocity model includes a continuous, three-dimensional near surface velocity model of the subsurface formation.

In another aspect combinable with one, some, or all of the previous aspects, the machine learning model includes an artificial neural network, a convolutional neural network, a long-short term memory model, a Gaussian process regression model, or a Fourier neural operators model.

In another aspect combinable with one, some, or all of the previous aspects, the instructions include selecting the subset of the seismic gathers by determining a geolocation of the seismic gathers; and selecting seismic gathers whose geolocation corresponds with a spatial position of the uphole seismic survey data.

What is claimed is:

1. A computer-implemented method for building a near surface velocity model for a subsurface formation, the method comprising:
obtaining, by one or more processors, seismic data representing a subsurface formation;
forming, by the one or more processors, seismic gathers based on the seismic data;
determining, by the one or more processors, uphole vertical velocities for the subsurface formation based on uphole seismic survey data;
forming, by the one or more processors, a training dataset comprising input features comprising a subset of the seismic gathers and labeled output data comprising the uphole vertical velocities corresponding to the subset of seismic gathers;
training, by the one or more processors, a machine learning model using the training dataset; and
generating, by the one or more processors, a near surface velocity model for the subsurface formation using the machine learning model that takes as input the seismic gathers.

2. The method of claim 1, wherein the seismic gathers comprise virtual shot gathers, common midpoint gathers, shot gathers, receiver gathers, or common image gathers.

3. The method of claim 1, wherein the seismic gathers comprise virtual shot gathers, and forming the virtual shot gathers comprises:
sorting, by the one or more processors, the seismic data into bins in a midpoint and offset hypercube;
performing, by the one or more processors, surface-consistent corrections to the sorted seismic data;
stacking, by the one or more processors, seismic traces in each hypercube bin; and
forming, by the one or more processors, the virtual shot gathers by collecting the stacked seismic traces for offset bins in the hypercube.

4. The method of claim 3, further comprising transforming, by the one or more processors, the virtual shot gathers to a Laplace-Fourier domain, wherein the virtual shot gathers are represented by a normalized amplitude and an unwrapped and normalized phase.

5. The method of claim 1, wherein the near surface velocity model comprises a continuous, three-dimensional near surface velocity model of the subsurface formation.

6. The method of claim 1, wherein the machine learning model comprises an artificial neural network, a convolutional neural network, a long-short term memory model, a Gaussian process regression model, or a Fourier neural operators model.

7. The method of claim 1, further comprising selecting the subset of the seismic gathers by determining, by the one or more processors, a geolocation of the seismic gathers; and selecting seismic gathers whose geolocation corresponds with a spatial position of the uphole seismic survey data.

8. The method of claim 1, further comprising:
identifying, by the one or more processors, a location to drill a well in the subsurface formation based on the near surface velocity model and the seismic data; and
drilling a well at the identified location by controlling, by the one or more processors, drilling equipment to drill the well.

9. A computer system comprising:
one or more processors; and
a computer-readable medium storing instructions executable by the one or more processors, the instructions when executed by the one or more processers cause the one or more processors to perform operations comprising:
obtaining seismic data representing a subsurface formation;
forming seismic gathers based on the seismic data;
determining uphole vertical velocities for the subsurface formation based on uphole seismic survey data;
forming a training dataset comprising input features comprising a subset of the seismic gathers and labeled output data comprising the uphole vertical velocities corresponding to the subset of seismic gathers;
training a machine learning model using the training dataset; and
generating a near surface velocity model for the subsurface formation using the machine learning model that takes as input the seismic gathers.

10. The computer system of claim 9, wherein the seismic gathers comprise virtual shot gathers, common midpoint gathers, shot gathers, receiver gathers, or common image gathers.

11. The computer system of claim 9, wherein the seismic gathers comprise virtual shot gathers, and forming the virtual shot gathers comprises:
sorting the seismic data into bins in a midpoint and offset hypercube;
performing surface-consistent corrections to the sorted seismic data;
stacking seismic traces in each hypercube bin; and
forming the virtual shot gathers by collecting the stacked seismic traces for offset bins in the hypercube.

12. The computer system of claim 9, wherein the near surface velocity model comprises a continuous, three-dimensional near surface velocity model of the subsurface formation.

13. The computer system of claim 9, wherein the machine learning model comprises an artificial neural network, a convolutional neural network, a long-short term memory model, a Gaussian process regression model, or a Fourier neural operators model.

14. The computer system of claim 9, wherein the instructions further comprise selecting the subset of the seismic gathers by determining a geolocation of the seismic gathers; and selecting seismic gathers whose geolocation corresponds with a spatial position of the uphole seismic survey data.

15. One or more non-transitory, machine-readable storage devices storing instructions executable by a computer system, the instructions when executed cause the computer system to perform operations comprising:
obtaining seismic data representing a subsurface formation;
forming seismic gathers based on the seismic data;
determining uphole vertical velocities for the subsurface formation based on uphole seismic survey data;
forming a training dataset comprising input features comprising a subset of the seismic gathers and labeled output data comprising the uphole vertical velocities corresponding to the subset of seismic gathers;
training a machine learning model using the training dataset; and
generating a near surface velocity model for the subsurface formation using the machine learning model that takes as input the seismic gathers.

16. The one or more non-transitory, machine-readable storage devices of claim 15, wherein the seismic gathers comprise virtual shot gathers, and forming the virtual shot gathers comprises:
sorting the seismic data into bins in a midpoint and offset hypercube;
performing surface-consistent corrections to the sorted seismic data;
stacking seismic traces in each hypercube bin; and
forming the virtual shot gathers by collecting the stacked seismic traces for offset bins in the hypercube.

17. The one or more non-transitory, machine-readable storage devices of claim 16, wherein the instructions further comprise transforming the virtual shot gathers to a Laplace-Fourier domain, wherein the virtual shot gathers are represented by a normalized amplitude and an unwrapped and normalized phase.

18. The one or more non-transitory, machine-readable storage devices of claim 15, wherein the near surface velocity model comprises a continuous, three-dimensional near surface velocity model of the subsurface formation.

19. The one or more non-transitory, machine-readable storage devices of claim 15, wherein the machine learning model comprises an artificial neural network, a convolutional neural network, a long-short term memory model, a Gaussian process regression model, or a Fourier neural operators model.

20. The one or more non-transitory, machine-readable storage devices of claim 15, wherein the instructions further comprise selecting the subset of the seismic gathers by determining a geolocation of the seismic gathers; and selecting seismic gathers whose geolocation corresponds with a spatial position of the uphole seismic survey data.
